(19) United States
(12) Patent Application Publication
(10) Pub. No.: US 2024/0402928 A1
(43) Pub. Date: Dec. 5, 2024

(54) METHOD, DEVICE, AND COMPUTER PROGRAM PRODUCT FOR FILE SYSTEM

(71) Applicant: Dell Products L.P., Round Rock, TX (US)

(72) Inventors: Helen Dong, Chengdu (CN); Yang Zhao, Chengdu (CN); Xuhui Yang, Chengdu (CN); Henry Tong, Chengdu (CN)

(21) Appl. No.: 18/361,655

(22) Filed: Jul. 28, 2023

(30) Foreign Application Priority Data
May 31, 2023 (CN) 202310640544.3

(51) Int. Cl. G06F 3/06; G06F 16/182

(52) U.S. Cl. CPC G06F 3/0637; G06F 3/061; G06F 3/0619; G06F 3/067; G06F 16/183

(57) ABSTRACT

The present disclosure generally relates to file systems. For instance, an example method includes determining a delegation enable status of the file system and determining the number of access requests from clients to a file in the file system within a predetermined time period. The method further includes determining a recall ratio within the predetermined time period based on the delegation enable status and the number of the access requests. In addition, the method further includes updating the delegation enable status of the file system by comparing the recall ratio with a delegation enable threshold. In this way, the method can utilize a delegation to improve the I/O operation performance, reduce a decrease of the I/O operation performance caused by enabling the delegation, reduce the consumption of client and server resources, reduce system latency, and improve user experience.

### RELATED APPLICATION

The present application claims the benefit of priority to Chinese Patent Application No. 202310640544.3, filed on May 31, 2023, which application is hereby incorporated into the present application by reference herein in its entirety.

### TECHNICAL FIELD

The present disclosure relates to the field of data storage, and more particularly, to a method, a device, and a computer program product for a file system.

### BACKGROUND

A network file system (NFS) is a distributed file system protocol, in which a client host can access server-side files, through a process the same as accessing a local storage. The NFS implements data storage, access, and sharing in a computer network, and allows storage resources (such as files) to be provided to a plurality of clients through the network, enabling them to access and manage data in a distributed and shared manner. The NFS provides high-level file access abstraction and supports operations such as reading, writing, creating, and deleting files. The NFS is widely applied in distributed computing environments, storage systems, cloud computing, and other scenarios.

Optimizing the performance of the NFS file system can reduce the file access latency and response time, and improve the data transmission speed. This is particularly important for applications or users who need to frequently read or write large amounts of data, as it can improve the work efficiency and productivity. Performance issues may cause data inconsistency or loss. By improving the performance of the NFS file system, errors and losses during data transmission can be reduced, thereby ensuring the data consistency and reliability.

### SUMMARY

Embodiments of the present disclosure propose a method, a device, and a computer program product for a file system. In the embodiments of the present disclosure, a recall ratio in a past predetermined time period may be determined, and then a delegation enable status of the file system may be updated by comparing the recall ratio with a delegation enable threshold. This approach can improve the I/O operation performance, save client and server resources, reduce the system latency, and improve the user experience.

In a first aspect of the embodiments of the present disclosure, a method for a file system is provided. The method includes determining a delegation enable status of the file system. The method further includes determining the number of a plurality of access requests from a plurality of clients to a file in the file system within a predetermined time period. The method further includes determining a recall ratio within the predetermined time period based on the delegation enable status and the number of the plurality of access requests. In addition, the method further includes updating the delegation enable status of the file system by comparing the recall ratio with a delegation enable threshold.

In a second aspect of the embodiments of the present disclosure, an electronic device is provided. The electronic device includes one or more processors; and a storage apparatus, for storing one or more programs, wherein the one or more programs, when executed by the one or more processors, cause the one or more processors to implement a method, and the method includes determining a delegation enable status of a file system. The method further includes determining the number of a plurality of access requests from a plurality of clients to a file in the file system within a predetermined time period. The method further includes determining a recall ratio within the predetermined time period based on the delegation enable status and the number of the plurality of access requests. In addition, the method further includes updating the delegation enable status of the file system by comparing the recall ratio with a delegation enable threshold.

In a third aspect of the embodiments of the present disclosure, a computer readable storage medium is provided, on which a computer program is stored. The program, when executed by a processor, implements a method, and the method includes determining a delegation enable status of a file system. The method further includes determining the number of a plurality of access requests from a plurality of clients to a file in the file system within a predetermined time period. The method further includes determining a recall ratio within the predetermined time period based on the delegation enable status and the number of the plurality of access requests. In addition, the method further includes updating the delegation enable status of the file system by comparing the recall ratio with a delegation enable threshold.

It should be understood that the content described in the Summary of the application part is neither intended to limit key or essential features of the embodiments of the present disclosure, nor intended to limit the scope of the present disclosure. Other features of the present disclosure will become readily understood from the following description.

### BRIEF DESCRIPTION OF THE DRAWINGS

The above and other features, advantages, and aspects of the embodiments of the present disclosure will become more apparent with reference to the accompanying drawings and the following detailed description. In the accompanying drawings, identical or similar reference numerals represent identical or similar elements, in which

FIG. 1 shows a schematic diagram of an example environment in which a plurality of embodiments of the present disclosure can be implemented;

FIG. 2 shows a schematic diagram of a process for granting a delegation and recalling a delegation according to some embodiments of the present disclosure;

FIG. 3 shows a flow chart of a method for a file system according to some embodiments of the present disclosure;

FIG. 4A shows a schematic diagram of an example suitable for enabling a delegation, in which a plurality of clients accesses a plurality of files in a file system when delegation is not enabled according to some embodiments of the present disclosure;

FIG. 4B shows a schematic diagram of an example not suitable for enabling a delegation, in which a plurality of clients accesses a plurality of files in a file system when delegation is not enabled according to some embodiments of the present disclosure;

FIG. 5 shows a schematic diagram of an example of a plurality of clients accessing a plurality of files in a file system when delegation is enabled according to some embodiments of the present disclosure;

FIG. 6 shows a schematic diagram of a process of enabling or disabling a delegation by dynamically determining a delegation enable threshold according to some embodiments of the present disclosure;

FIG. 7 shows a schematic diagram of a process of determining a delegation enable threshold according to some embodiments of the present disclosure; and

FIG. 8 shows a block diagram of a device that can implement a plurality of embodiments of the present disclosure.

### DETAILED DESCRIPTION

The following will describe the embodiments of the present disclosure in more detail with reference to the accompanying drawings. Although the accompanying drawings show some embodiments of the present disclosure, it should be understood that the present disclosure may be implemented in various forms, and should not be explained as being limited to the embodiments stated herein. Rather, these embodiments are provided for understanding the present disclosure more thoroughly and completely. It should be understood that the accompanying drawings and embodiments of the present disclosure are for exemplary purposes only, and are not intended to limit the protection scope of the present disclosure.

In the description of the embodiments of the present disclosure, the term “include” and similar terms thereof should be understood as open-ended inclusion, that is, “including but not limited to.” The term “based on” should be understood as “based at least in part on.” The term “an embodiment” or “the embodiment” should be understood as “at least one embodiment.” The terms “first,” “second,” and the like may refer to different or identical objects. Other explicit and implicit definitions may also be included below.

In some versions of NFS, a server may use a “delegation” to delegate file management to a client. For example, the server may grant a read delegation or a write delegation to the client. The read delegation may be granted to a plurality of clients simultaneously because these read delegations do not conflict with each other. The write delegation may only be granted to one client because the write delegation conflicts with any file access from any other client. When holding a write delegation, the client does not send an I/O request to the server because the client can be guaranteed with exclusive access to the file. Likewise, the client does not send an I/O request to the server while holding the read delegation. This is because the server guarantees that no client can open a file in a write mode. The delegation can greatly reduce interaction between the server and the client on a delegation file. Therefore, it reduces the consumption of network resources and improves the performance of the client and the server.

In some cases, the server can “recall” the delegation. When a manner of the client accessing a file is inconsistent with a delegation currently granted to the file, a conflict occurs. For example, if a client holds a write delegation to a file and another client opens the file for reading or writing access, the server will recall the write delegation of the first client. Similarly, if a client holds a read delegation and another client opens the same file for writing, the server will recall the read delegation of the first client. When a conflict occurs, the server uses a callback mechanism to contact the client currently holding the delegation. After receiving this callback, the client sends an updated status of the file to the server and returns the delegation. The objective of providing a delegation is to reduce interaction between the server and the client, thereby improving the I/O operation performance. However, the recall process requires more time than a usual I/O operation. Therefore, frequent recalls may lead to a decrease of the I/O operation performance, and even lower the I/O operation performance than that when the delegation function is not used.

Therefore, the embodiments of the present disclosure propose a solution for updating a delegation enable status of a file system. In the embodiments of the present disclosure, a delegation analyzer located at the server may monitor data associated with a given file system during a past predetermined time period, such as the number of accesses to a file in the file system requested by the clients, and then determine a recall ratio during the predetermined time period based on the monitored data. The solution updates the delegation enable status of the file system by comparing the recall ratio with a delegation enable threshold.

In this way, the solution provided by the embodiments of the present disclosure can automatically enable or disable a delegation for a file system based on different situations of clients accessing the file system, thereby utilizing the delegation to improve I/O operation performance. At the same time, it can also reduce the decrease in I/O operation performance caused by enabling a delegation, reduce the consumption of client and server resources, reduce the system latency, and improve the user experience.

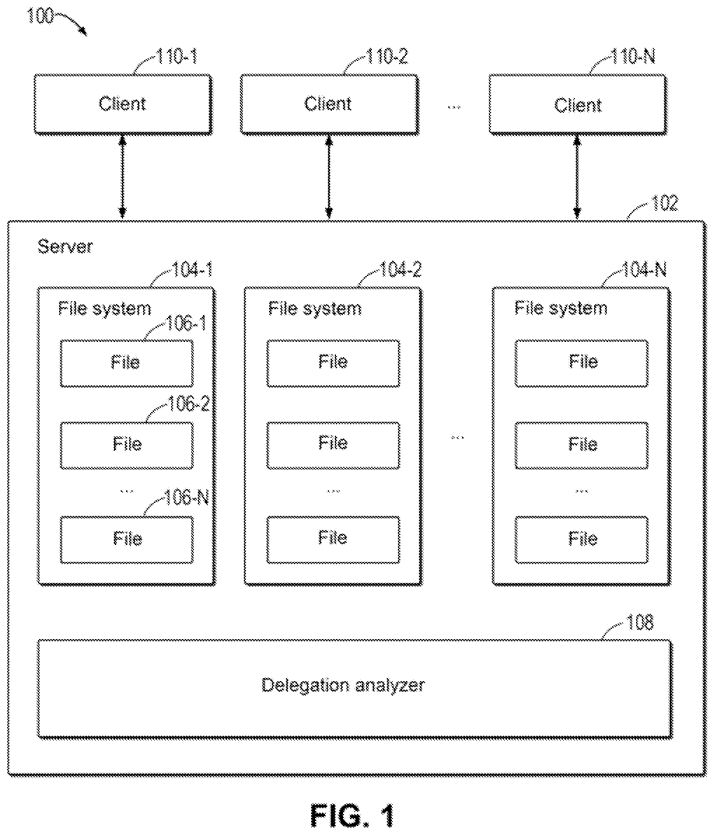

FIG. 1 shows a schematic diagram of an example environment 100 in which a plurality of embodiments of the present disclosure can be implemented. As shown in FIG. 1, the environment 100 includes a server 102 and a plurality of clients, namely clients 110-1, 110-2, . . . , and 110-N (collectively referred to as a client 110). The server 102 includes a plurality of file systems, namely file systems 104-1, 104-2, . . . , and 104-N (collectively referred to as a file system 104). A plurality of files is stored in the file system 104, for example, in the environment 100, the file system 104-1 stores files 106-1, 106-2, . . . , and 106-N (collectively referred to as a file 106). The client 110 may send an access request to the server 102, such as file reading, file writing, file creation, and file deletion for the file 106 in the file system 104. The access request typically includes a file path and a related operation. When delegation is not enabled, the server 102 may perform the corresponding operation on the file 106 in the file system 104 after receiving the access request, and then return a result to the client 110. When delegation is enabled, the server 102 may grant the delegation to the client 110, so that the client 110 can autonomously handle read and write operations to the file 106 within a certain time range. Synchronization with the server is performed only when the delegation times out or needs to share an access with another client, and there is no need for frequent communication with the server 102. In this way, the network latency and bandwidth consumption may be reduced, thereby improving the I/O operation performance.

In some cases, the server 102 may recall the delegation of the file previously granted to the client. For example, after the server 102 grants the client 110-1 with the delegation to the high file 106-1 in the file system 104-1, there may be a conflict when the client 110-2 also requests access to the file 106-1. Therefore, the server 102 may recall the delegation to the file 106-1 that is previously granted to the client 110-1, and then the server 102 may grant the client 110-2 with a delegation to the file 106-1.

As shown in FIG. 1, in the environment 100, the server 102 further includes a delegation analyzer 108, and the delegation analyzer 108 may collect statistical data, such as the number of times the file system 104 is accessed per second, the numbers of times the file 106 is accessed by each of a plurality of clients 110 within a time period, and the number of times a delegation is recalled when delegation is enabled. The delegation analyzer 108 may also analyze these statistical data to decide whether the delegation needs to be enabled or disabled for a certain file system 104. By collecting and analyzing I/O access data over a time period in the past, and automatically deciding to enable or disable the delegation for the file system 104 by using the delegation analyzer 108, interaction between the server 102 and the client 110 can be reduced, thereby improving the I/O operation performance and saving network resources.

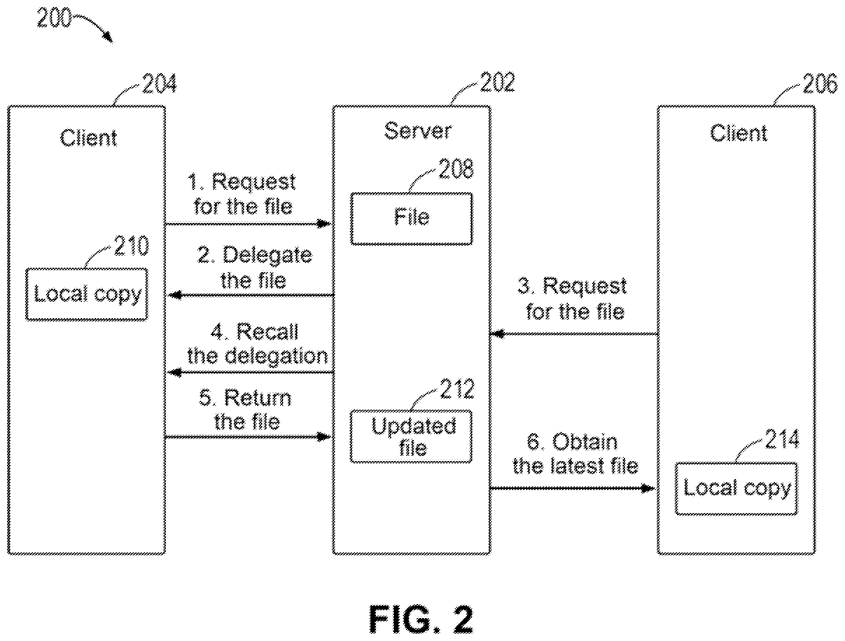

FIG. 2 shows a schematic diagram of a process 200 for granting a delegation and recalling a delegation according to some embodiments of the present disclosure. As shown in FIG. 2, a file 208 is stored in a file system of a server 202 (for example, the server 102 in FIG. 1), and the server 202 has enabled delegation. In the process 200, a client 204 (for example, the client 110-1 in FIG. 1) needs to perform an I/O operation on the file 208, and therefore, the client 204 may send an access request for the file 208 to the server 202. After receiving the access request, the server 202 may grant a delegation for the file 208 to the client 204. Then, the client 204 may save a local copy 210 of the file 208 locally, so that when it is required to perform an I/O operation on the file 208 in the following period of time, the client 204 can directly perform an I/O operation on the local copy 210 without the need of sending an access request to the server 202.

In the process 200 shown in FIG. 2, when the client 204 holds the delegation for the file 208, a client 206 (for example, the client 110-2 in FIG. 1) needs to perform an I/O operation on the file 208, and therefore, the client 206 may send an access request for the file 208 to the server 202. After the server 202 receives the access request, the server 202 finds that the client 204 is holding the delegation for the file 208. Therefore, the server 202 can use a callback mechanism to recall the delegation for the file 208 from the client 204. In the process 200, after receiving the recall, the client 204 returns the updated local copy 210 to the server 202, and the server 202 may replace the currently stored file 208 with the received updated file, so that the file 208 is replaced with an updated file 212. Then, the server 202 may delegate the updated file 212 to the client 206. Then, the client 206 may save a local copy 214 of the updated file 212 locally.

As shown in FIG. 2, in the process 200, there are four communications between the server 202, the client 204, and the client 206 from the client 206 sending the access request for the file 208 to the server 202 to obtain the updated file 212. That is, the client 206 sends the access request to the server 202, the server 202 sends a recall command to the client 204, the client 204 returns the updated local copy 210 to the server 202, and the server 202 sends the updated file 212 to the client 206. However, if a delegation is not enabled by the server 202, this process only requires two communications between the server 202 and the client 206, that is, the client 206 sends the access request for the file 208 to the server 202, and the server 202 returns a result of the access request to the client 206.

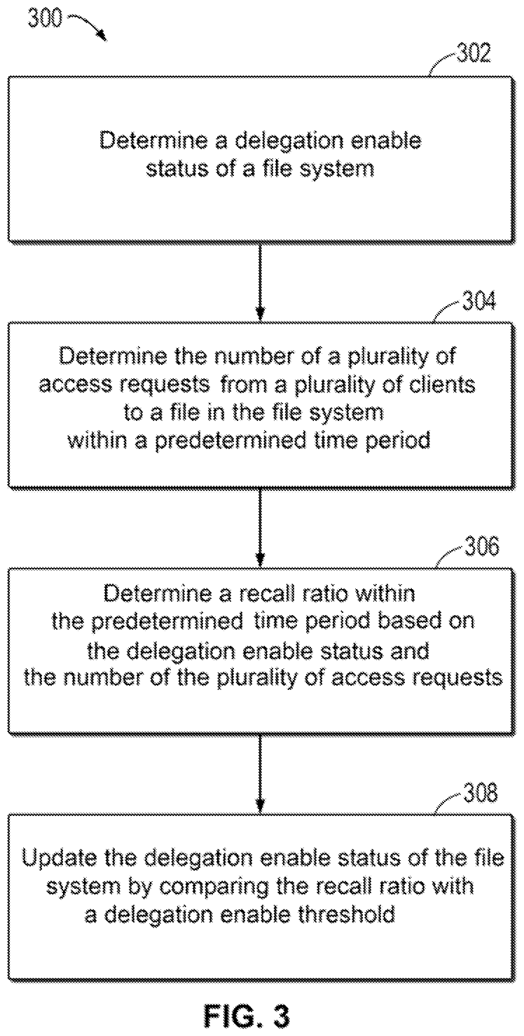

FIG. 3 shows a flow chart of a method 300 for authentication according to some embodiments of the present disclosure. As shown in FIG. 3, at a block 302, the method 300 may determine a delegation enable status of a file system. For example, the delegation enable status of the file system may be enabled or disabled. At a block 304, the method 300 may determine the number of a plurality of access requests from a plurality of clients to a file in the file system within a predetermined time period. For example, in the environment 100 shown in FIG. 1, the method 300 may determine the number of times the client 110-1 requests access to the file 106-1 in file system 104-1, the number of times the client 110-1 requests access to the file 106-2, the number of times the client 110-2 requests access to the file 106-1, the number of times the client 110-2 requests access to the file 106-2, and so on during a past predetermined time period.

At a block 306, the method 300 may determine a recall ratio within the predetermined time period based on the delegation enable status and the number of the plurality of access requests. For example, if the delegation enable status of the file system is enabled, the method 300 may determine a ratio of the number of recalls that actually occurred in a past predetermined time period to a total number of access requests. If the delegation enable status of the file system is disabled, the method 300 may predict, based on the number of times the files in the file system are requested to access by the clients, a ratio of the number of recalls that may occur within the past predetermined time period to a total number of accesses.

At a block 308, the method 300 may update the delegation enable status of the file system by comparing the recall ratio with the delegation enable threshold. For example, when the recall ratio is greater than the delegation enable threshold, it indicates that the number of recalls is large, leading to a decrease in the I/O operation performance of the overall environment. Therefore, when the delegation enable status of the file system is enabled, it may be updated to disabled, or when the delegation enable status is disabled, it may be kept disabled. On the contrary, when the recall ratio is less than or equal to the delegation enable threshold, it indicates that the number of recalls is small. Therefore, when the delegation enable status of the file system is disabled, it may be updated to enabled, thereby improving the I/O operation performance, or when the delegation enable status is enabled, it may be kept in the enabled status.

In this way, the method 300 can automatically enable or disable the delegation for the file system based on different situations of a client accessing the file system, thereby being capable of improving the I/O operation performance through the delegation. At the same time, it can reduce a decrease in the I/O operation performance caused by enabling of the delegation, reduce the consumption of client and server resources, reduce the system latency, and improve the user experience.

In some embodiments, if the delegation enable status of the file system is disabled, in order to estimate a predicted recall ratio of enabling the delegation within a predetermined time period, a predicted total number of recalls within the predetermined time period may be estimated based on the number of access requests from a plurality of clients to a plurality of files in a given file system during the predetermined time period. In these embodiments, a total number of access requests during the predetermined time period may also be determined. Then, the predicted recall ratio may be determined based on the predicted total number of recalls and the total number of access requests. In some embodiments, in response to the recall ratio being less than or equal to the delegation enable threshold, the delegation enable status of the file system may be updated to enabled.

In some embodiments, in order to estimate the predicted total number of recalls within the predetermined time period, for each file in a given file system, a degree of dispersion of the numbers of access requests made by the clients to the file may be determined, and the predicted number of recalls for the file may be determined based on the degree of dispersion. Then, the predicted total number of recalls may be determined by determining a plurality of predicted numbers of recalls for a plurality of files.

In some embodiments, the degree of dispersion of the numbers of access requests for a given file by the clients may be determined by calculating a standard deviation of the numbers of access requests for the file by the clients. In these embodiments, an average number of access requests for the file by a plurality of clients may be determined. Then, the standard deviation of the numbers of file access requests by the clients is determined based on the average number of access requests.

In order to estimate the recall ratio after a delegation is enabled when delegation is not enabled, a delegation analyzer (such as the delegation analyzer 108 in FIG. 1) needs to collect data associated with the file system, such as the number of clients and the number of I/O requests per second of the file system. Assuming that there are K servers in a storage system, each server

k includes N file systems, and for each file system fsᵢ, a client connected to the file system is C_{i,j}, then the number of clients connected to the file system fsᵢ is NCᵢ, wherein 1≤j≤NCᵢ. The number of access requests from the client j to the file system fsᵢ is CIO_{i,j}, the number of access requests per second of the file system fsᵢ is fs_{i_iops}, and therefore, the total number of access requests FIOᵢ of the file system fsᵢ in the past predetermined time period may be obtained through the following equation (1):

$${FIO}_{i} = {\sum }_{j = 0}^{j = {NC}_{i}} {CIO}_{i , j} \qquad ( 1 )$$

M represents the number of files on the file system fsᵢ, and fᵢₘ represents each file, wherein 5≤m≤M. For each file fᵢₘ, access requests for it come from different clients C_{i,j}, and therefore, the number of access requests to the file fᵢₘ may be represented as a sequence IOfᵢₘ=[IOf_{im,i}]=[IOf_{im,1}, IOf_{im,2}, . . . IOf_{im,NCi}]. The total number of access requests IOf_{im_total} for the file fᵢₘ may be determined through the following equation (2):

$${IOf}_{im \_ total} = {\sum }_{j = 0}^{j = {NC}_{i}} {IOf}_{im , j} \qquad ( 2 )$$

In some embodiments, in order to determine a distribution status of the numbers of access requests from the plurality of clients to the file fᵢₘ, a standard deviation σᵢₘ of the sequence IOfᵢₘ may be calculated through the following equation (3):

$${σ}_{im} = \sqrt{\frac{{\sum }_{j = 1}^{j = {NC}_{i}} {( {IOf}_{im , j} - {IOf}_{im \_ average} )}^{2}}{{NC}_{i}}} \qquad ( 3 )$$

wherein f_{im_average} represents an average number of access requests from the plurality of clients to the file fᵢₘ.

The standard deviation σᵢₘ may represent the degree of dispersion of the numbers of access requests from the plurality of clients to the file fᵢₘ. After σᵢₘ is determined, the predicted recall ratio Ri when delegation is enabled during the predetermined time period may be calculated by using the following equation (4):

$${R}_{i} = \frac{{\sum }_{m = 1}^{m = M} {IOf}_{im} * ( 1 - {σ}_{im} )}{{FIO}_{i}} \qquad ( 4 )$$

If a delegation is enabled for the file system fsᵢ, more recalls may occur when different clients alternately request access to the file fᵢₘ on the file system. Therefore, the smaller the standard deviation σᵢₘ of the number of access requests from the plurality of clients to the file fᵢₘ is, the more evenly distributed the number of access requests to the file fᵢₘ is across the plurality of clients C_{i,j}, and the higher the recall ratio may be. In this case, not enabling a delegation for the file system fsᵢ can achieve better I/O operation performance. On the contrary, the larger the standard deviation σᵢₘ of the number of access requests from the plurality of clients to the file fᵢₘ, the less evenly distributed the number of access requests to the file fᵢₘ is across the plurality of clients C_{i,j}, and the lower the recall ratio may be. In this case, enabling a delegation for the file system fsᵢ can improve the I/O operation performance.

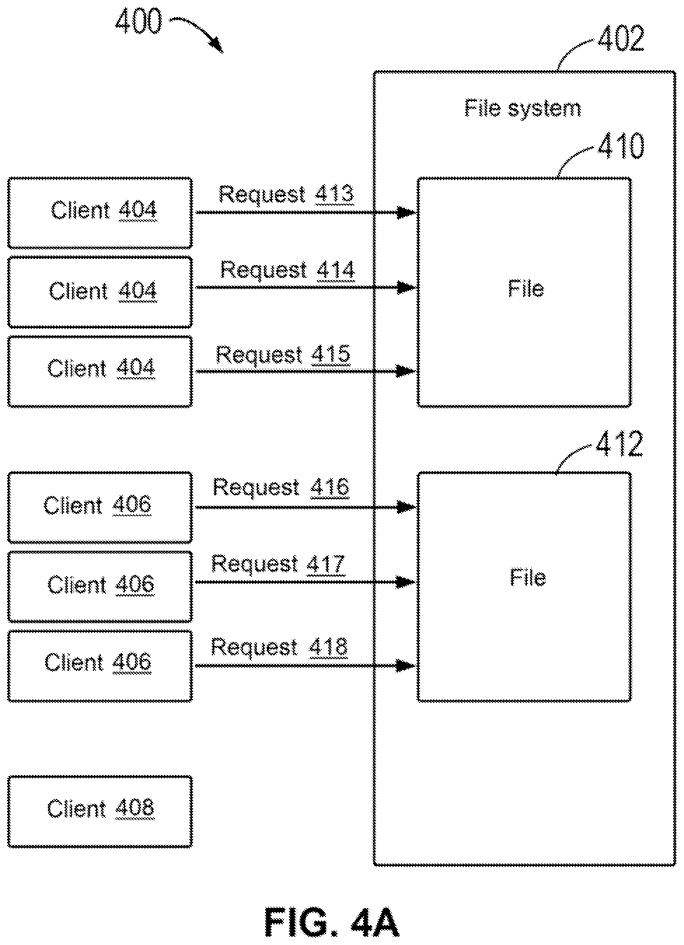

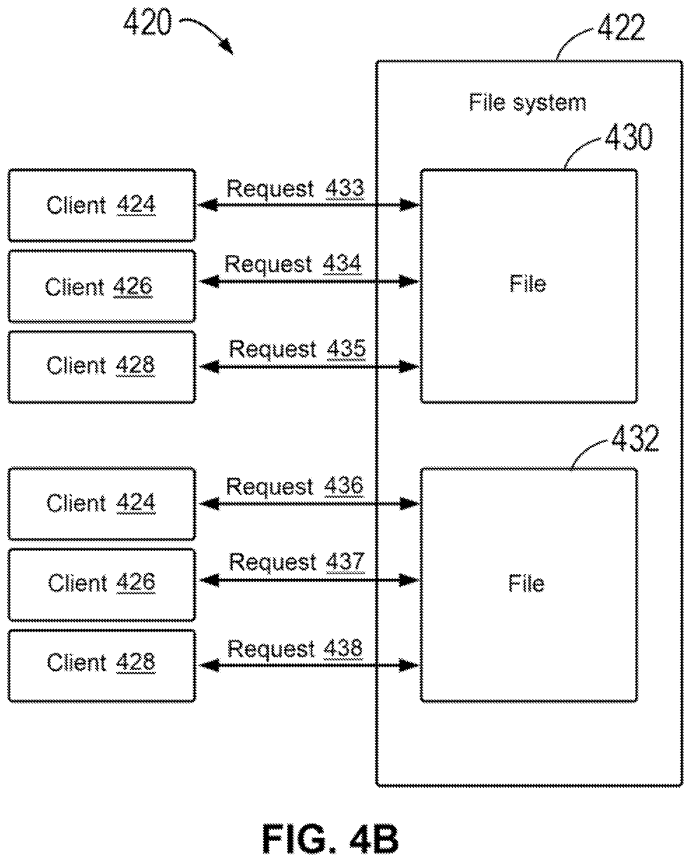

FIG. 4A to FIG. 4B show schematic diagrams of an example of a plurality of clients accessing a plurality of files in a file system when delegation is not enabled according to some embodiments of the present disclosure. FIG. 4A shows a schematic diagram of an example 400 suitable for enabling a delegation, in which a plurality of clients accesses a plurality of files in a file system when delegation is not enabled according to some embodiments of the present disclosure. FIG. 4B shows a schematic diagram of an example 420 not suitable for enabling a delegation, in which a plurality of clients accesses a plurality of files in a file system when delegation is not enabled according to some embodiments of the present disclosure.

As shown in FIG. 4A, the example 400 includes a file system 402 and clients 404, 406, and 408, where the file system 402 includes files 410 and 412. During the past predetermined time period, three access requests (i.e., access requests 413, 414, and 415) to the file 410 are all from the client 404, and three access requests (i.e., access requests 416, 417, and 418) to the file 412 are all from the client 406. In the example 400, the client 408 may request access to another file in the file system 402, but does not request access to the files 410 and 412. It should be understood that for simplicity, other files in the file system 402 and other clients accessing the file system 402 are not shown in FIG. 4A, but it is not intended to limit the number of files included in the file system, the number of clients, or the number of access requests.

In the example 400 shown in FIG. 4A, for the file 410, the delegation analyzer 108 may calculate an average number of access requests from the clients 404, 406, and 408 to the file 410 based on the number of clients (i.e., 3 clients, namely the clients 404, 406, and 408) and the number of access requests from each client to the file 410 (i.e., the client 404 has 3 requests, namely 413, 414, and 415, and the clients 406 and 408 have 0 requests). Then, a standard deviation of the numbers of access requests from the clients 404, 406, and 408 to the file 410 is calculated by using the above equation (3). Similarly, in the example 400, for the file 412, the delegation analyzer 108 may calculate an average number of access requests from the clients 404, 406, and 408 to the file 412 based on the number of clients (i.e., 3 clients, namely the clients 404, 406, and 408) and the number of access requests from each client to the file 412 (i.e., the client 406 has 3 requests, namely 416, 417, and 418, and the clients 404 and 408 have 0 requests). Then, a standard deviation of the numbers of access requests from the clients 404, 406, and 408 to the file 412 is calculated by using the above equation (3). Then, the delegation analyzer 108 may calculate by using the above equation (4), based on the numbers of access requests of the clients 404, 406, and 408 to the files 410 and 412 and the standard deviations, the predicted recall ratio if a delegation is enabled for the file system 402 in the past predetermined time period. If the predicted recall ratio is less than or equal to the delegation enable threshold, the delegation enable status of the file system 402 may be updated to enabled.

In the example 400 shown in FIG. 4A, it can be seen that all access requests for the file 410 are unevenly from the client 404. In this case, the standard deviation of the numbers of access requests for the file 410 by the clients 404, 406, and 408 is relatively large. Similarly, in the example 400, the standard deviation of the numbers of access requests for the file 412 by the clients 404, 406, and 408 is also relatively large. If a delegation is enabled for the file system 402, there will be fewer recalls, and therefore, enabling the delegation can improve the I/O operation performance of the file system 402.

FIG. 4B shows a schematic diagram of an example 420 not suitable for enabling a delegation, in which a plurality of clients accesses a plurality of files in a file system when delegation is not enabled according to some embodiments of the present disclosure. As shown in FIG. 4B, the example 420 includes a file system 422 and clients 424, 426, and 428, where the file system 422 includes files 430 and 432. Within a past predetermined time period, three access requests (i.e., access requests 433, 434, and 435) to the file 430 came from the clients 424, 426, and 428 in sequence, and three access requests (i.e., access requests 436, 437, and 438) to the file 432 also came from the clients 424, 426, and 428 in sequence. It should be understood that for simplicity, other files in the file system 422 and other clients accessing the file system 422 are not shown in FIG. 4B, but it is not intended to limit the number of files included in the file system, the number of clients, or the number of access requests.

In the example 420 shown in FIG. 4B, for the file 430, the delegation analyzer 108 may calculate an average number of access requests from the clients 424, 426, and 428 to the file 430 based on the number of clients (i.e., 3 clients, namely the clients 424, 426, and 428) and the number of access requests from each client to the file 430 (i.e., the clients 424, 426 and 428 each have 1 request). Then, a standard deviation of the numbers of access requests from the clients 424, 426, and 428 to the file 430 is calculated by using the above equation (3). Similarly, in the example 420, for the file 432, the delegation analyzer 108 may calculate an average number of access requests from the clients 424, 426, and 428 to the file 432 based on the number of clients (i.e., 3 clients, namely the clients 424, 426, and 428) and the number of access requests from each client to the file 432 (i.e., the clients 424, 426 and 428 each have 1 request). Then, a standard deviation of the numbers of access requests from the clients 424, 426, and 428 to the file 432 is calculated by using the above equation (3). Then, the delegation analyzer 108 may calculate by using the above equation (4), based on the numbers of access requests of the clients 424, 426, and 428 to the files 430 and 432 and the standard deviations, the predicted recall ratio if a delegation is enabled for the file system 422 in the past predetermined time period. If the predicted recall ratio is less than or equal to the delegation enable threshold, the delegation enable status of the file system 422 may be updated to enabled.

In the example 420 shown in FIG. 4B, it can be seen that all access requests for the file 430 are evenly from the clients 424, 426, and 428. In this case, the standard deviation of the numbers of access requests for the file 430 by the clients 424, 426, and 428 is relatively small. Similarly, in the example 400, the standard deviation of the numbers of access requests for the file 432 by the clients 424, 426, and 428 is also relatively small. If a delegation is enabled for the file system 402, there will be many recalls, and therefore, disabling the delegation can reduce a decrease of the I/O operation performance of the file system 402.

In this way, the delegation analyzer can automatically determine whether enabling the delegation will improve or decrease the I/O operation performance of the file system, thereby dynamically adjusting the delegation enable status of the file system to improve or reduce the I/O operation performance of the file system, thereby saving network resources, reducing the latency, and improving the user experience.

In some embodiments, if it is determined that the delegation enable status of the file system is enabled, the number of the plurality of access requests from the plurality of clients to the file in the file system within the predetermined time period may be determined, and the number of number of recalls associated with the file within the predetermined time period may be determined. Then, the actual recall ratio may be determined based on the number of the plurality of access requests and the number of recalls. In some embodiments, in response to the recall ratio being greater than the delegation enable threshold, the delegation enable status of the file system may be updated to disabled.

In some embodiments, a total number IOₜₒₜₐₗ of access requests from a plurality of clients to a file in the file system within a predetermined time period and the total number IO_{recall} of recalls may be determined. Then, an actual recall ratio Ri of the file system fₛᵢ when delegation is enabled may be calculated by using the following equation (5):

$${R}_{i} = \frac{{IO}_{recall}}{{IO}_{total}} \qquad ( 5 )$$

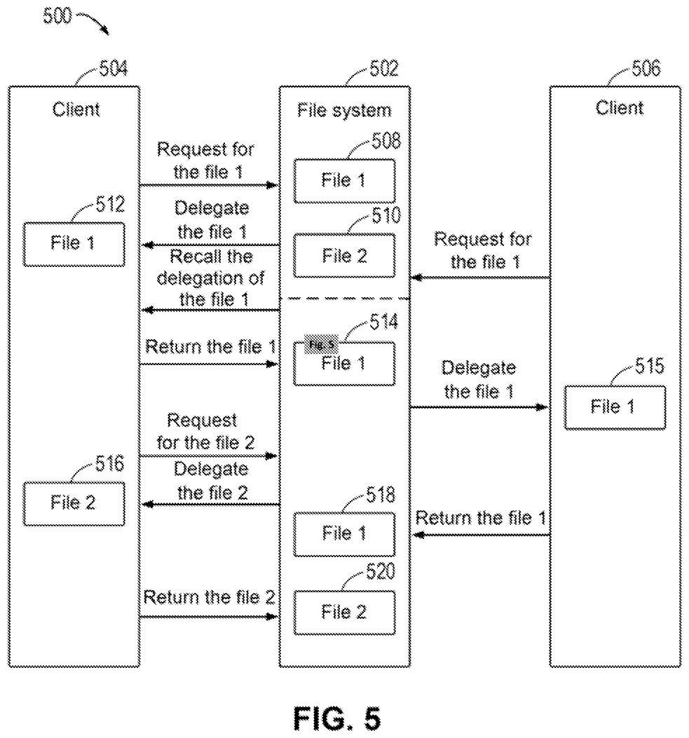

FIG. 5 shows a schematic diagram of an example 500 of a plurality of clients accessing a plurality of files in a file system when delegation is enabled according to some embodiments of the present disclosure. As shown in FIG. 5, the example 500 includes a file system 502 and clients 504 and 506, where the file system 502 includes a file 1 508 and a file 2 510. During a past predetermined time period, the client 504 requests access to the file 1 508, and then the server (such as the server 102 in FIG. 1) may grant a delegation of the file 1 508 to the client 504, thereby generating a local copy 512 of the file 1 508 at the client 504. Then, the client 506 also requests access to the file 1 508, and therefore, the server sends a command to recall the delegation of the file 1 to the client 504. After receiving the recall command, the client 504 returns the updated local copy 512 to the server, thus updating the file 1 508 at the file system 502 to a file 1 514. Then, the server may grant a delegation of the file 1 514 to the client 506. In the example 500, a client 1 may also request access to the file 2 510 from the server, the server grants a delegation of the file 2 510 to the client 504 and generates a local copy 516 of the file 2 510 at the client 504. After timeout of the delegations granted by the server to the clients 504 and 506, the client 506 returns an updated file 1 518, and the client 504 returns an updated file 2 520.

In the example 500 shown in FIG. 5, the delegation analyzer (for example, the delegation analyzer 108 in FIG. 1) may determine the total number of access requests from the clients 504 and 506 to the files 1 508 and 2 510 in the file system 502 during the time period (i.e., a total of 3 requests, including 2 requests of the client 504 and 1 request of the client 506) and the total number of recalls (i.e., a total of 1 recall). Then, the delegation analyzer may determine, by using the above equation (5), an actual recall ratio of the file system 502 based on the total number of access requests and the total number of recalls. If the actual recall ratio is greater than the delegation enable threshold, the delegation analyzer may update the delegation enable status of the file system 502 to disabled, thereby improving the I/O operation performance of the file system 502.

In this way, the delegation analyzer can automatically determine whether disabling the delegation will improve or decrease the I/O operation performance of the file system, thereby being capable of dynamically adjusting the delegation enable status of the file system to improve the I/O operation performance of the file system or reduce a decrease of the I/O operation performance of the file system.

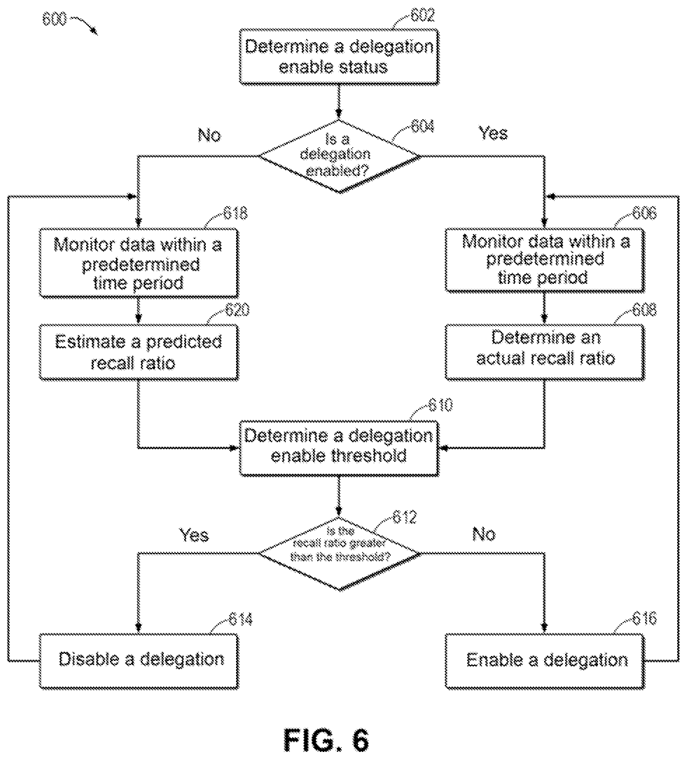

In some embodiments, the delegation analyzer may dynamically determine the delegation enable threshold according to data associated with the file system during the past predetermined time period. FIG. 6 shows a schematic diagram of a process 600 of enabling or disabling a delegation by dynamically determining a delegation enable threshold according to some embodiments of the present disclosure. As shown in FIG. 6, at a block 602, the process 600 determines whether a delegation enable status of a file system is enabled or disabled. At a block 604, if the process 600 determines that the delegation enable status of the file system is disabled, the procedure moves to a block 606.

At the block 606, the process 600 monitors data associated with the file system during a past predetermined time period when a delegation has been disabled. For example, a delegation analyzer can monitor the number of files in the file system, the number of clients connected to the file system, the number of access requests each client requests to access each file in the file system, the number of access requests per second for the file system, and so on. At a block 608, the delegation analyzer may calculate, by using the above equation (4), a predicted recall ratio if a delegation is enabled for the file system within the past predetermined time period based on the data monitored in the block 608.

Returning to the block 604, if the process 600 determines that the delegation enable status of the file system is enabled, the procedure moves to a block 618. At the block 618, the process 600 monitors data associated with the file system during the past predetermined time period when delegation is enabled. For example, the delegation analyzer can monitor the number of access requests to a file in the file system sent by each client to the server during the past predetermined time period, the number of recalls sent by the server to each client, and so on. At a block 620, the process 600 may determine an actual recall ratio associated with the file system in the past predetermined time period based on the number of the plurality of access requests and the number of the plurality of recalls collected in the block 618. For example, the delegation analyzer may calculate, based on the number of access requests to the file in the file system sent by each monitored client to the server, the total number of access requests sent by all clients. In addition, the delegation analyzer may further calculate the total number of recalls based on the high number of recalls sent by the monitored server to the clients. Then, the delegation analyzer may calculate, by using the above equation (5), the actual recall ratio associated with the file system based on the total number of access requests and the total number of recalls.

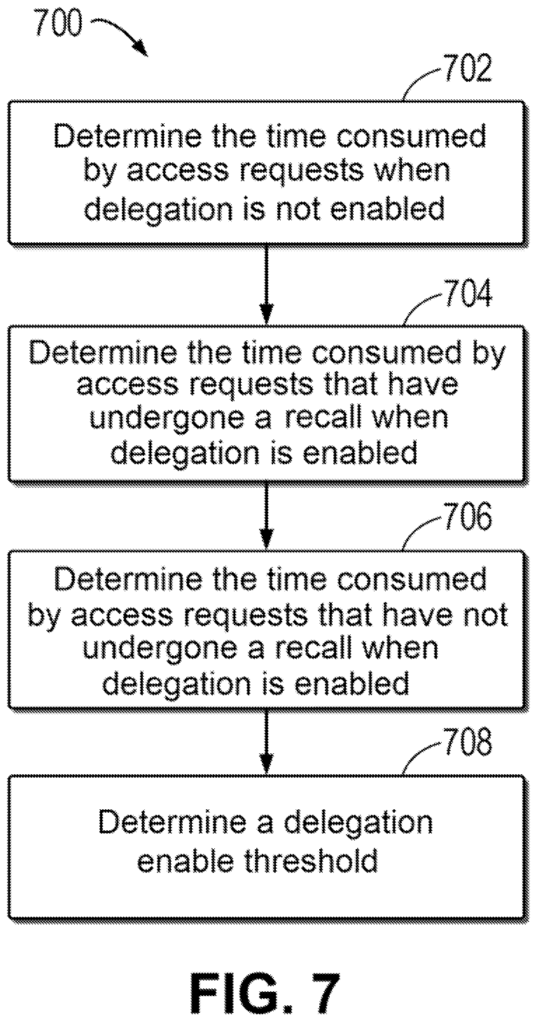

At a block 610, the process 600 may determine a delegation enable threshold based on the predicted recall ratio or actual recall ratio (collectively referred to as the recall ratio) within the past predetermined time period and the monitored data associated with the file system. A detailed process of determining the delegation enable threshold will be described with reference to FIG. 7 in the following. At a block 612, the process 600 may compare the recall ratio with the delegation enable threshold. If the recall ratio is greater than the delegation enable threshold, it indicates that enabling a delegation may result in many recalls, which may reduce the I/O operation performance of the file system. Therefore, at a block 614, the process 600 may update the delegation enable status to disabled or keep it disabled. On the contrary, if the recall ratio at the block 612 is less than or equal to the delegation enable threshold, it indicates that enabling a delegation may result in a small number of recalls, which may improve the I/O operation performance of the file system. Therefore, at a block 616, the process 600 may update the delegation enable status of the file system to enabled or keep it enabled.

In this way, the delegation enable threshold can be dynamically determined based on data within the past predetermined time period, so that the delegation analyzer can make an appropriate decision based on the latest data, thereby improving the accuracy of updating the delegation enable status of the file system, improving the I/O operation performance, or reducing a decrease in the I/O operation performance.

In order to determine the delegation enable threshold, in some embodiments, the delegation enable threshold may be determined based on the request time consumed by sending access requests, the response time consumed by receiving request responses, the total number of access requests of the file system within the predetermined time period, the number of requests per second of the file system within the predetermined time period, and the delegation timeout time. In some embodiments, the total time (also known as a first consumption time) consumed by a plurality of access requests to files in the file system may be determined when a delegation of the file system is not enabled within the predetermined time period. Then, the total time (also known as a second consumption time) consumed by a plurality of access requests to files in the file system may be determined when a delegation of the file system is enabled within the predetermined time period. Then, the delegation enable threshold may be determined based on the consumption time in the above two scenarios.

In some embodiments, the total time consumed by all access requests when a delegation is disabled may be determined based on the request time consumed by sending access requests, the response time consumed by receiving request responses, and the total number of access requests within the predetermined time period.

In some embodiments, in order to determine the total time consumed by all access requests when delegation is enabled, the total time (also known as a third consumption time) consumed by access requests that have undergone a recall and the total time (also known as a fourth consumption time) consumed by access requests that have not undergone a recall may be determined, and then the total time consumed by all access requests when delegation is enabled is determined based on the time consumed by the two parts of access requests.

In some embodiments, in order to determine the total time consumed by access requests that have undergone a recall, the third consumption time may be determined based on the time consumed by requests, the time consumed by responses, and the number of access requests that have undergone a recall. In some embodiments, in order to determine the total time consumed by access requests that have not undergone a recall, the total time consumed by access requests that have not undergone a recall may be determined based on the time consumed by requests, the time consumed by responses, the number of requests per second, the delegation timeout time, and the number of access requests that have not undergone a recall.

FIG. 7 shows a schematic diagram of a process 700 of determining a delegation enable threshold according to some embodiments of the present disclosure. At a block 702, the process 700 may determine the total time consumed by access requests to files in the file system when delegation is not enabled. For example, when delegation is not enabled, the time consumed by a client to send an access request to a file to the server is t₁, and the time consumed by the client to receive a response to the access request from the server is t₂. Usually, t₁ is close to t₂. Therefore, in order to simplify the equation, it is assumed herein that both t₁ and t₂ are equal to t. Therefore, the time consumed by the client to obtain a file permission is 2t. The total consumption time two of the file system may be calculated by using the following equation (6):

$${t}_{wo} = {FIO}_{i} * 2 t \qquad ( 6 )$$

wherein FIOᵢ is the total number of access requests of the file system.

It should be understood that when t₁ is not equal to t₂, the equations listed herein may be further utilized by replacing 2t with t₁+t₂.

At a block 704, the process 700 may determine the time consumed by access requests that have undergone a recall in all access requests when delegation is enabled. For example, the total time t_{w_r} consumed by access requests that have undergone a recall may be determined through the following equation (7):

$${t}_{w \_ r} = 4 t * {FIO}_{i} * {R}_{i} \qquad ( 7 )$$

wherein Rᵢ is the recall ratio.

At a block 706, the process 700 may determine the time consumed by access requests that have not undergone a recall in all access requests when delegation is enabled. For example, the total time t_{w_wor} consumed by access requests that have not undergone a recall may be determined through the following equation (8):

$${t}_{w \_ wor} = \frac{2 t}{T * {fs}_{i \_ iops}} * {FIO}_{i} * ( 1 - {R}_{i} ) \qquad ( 8 )$$

wherein Tis the delegation timeout time. The delegation timeout time refers to a time that the client can maintain a delegation of a file after obtaining the delegation. When the time of the client maintaining the delegation exceeds the delegation timeout time T, the client needs to request access to the file from the server again. f_{si_iops} is the number of access requests per second of the file system fₛᵢ.

At a block 708, the process 700 may determine the delegation enable threshold based on the total time t_{wo} consumed by all access requests when delegation is not enabled, the total time f_{w_r} consumed by access requests that have undergone a recall when delegation is enabled, and the total time f_{w_wor} consumed by access requests that have not undergone a recall when delegation is enabled. For example, when the recall ratio Rᵢ makes the total time consumed by all access requests when delegation is enabled equal to the total time consumed by all access requests when delegation is not enabled (that is, (t_{w_r}+f_{w_wor})=t_{wo}), the I/O operation performance when delegation is enabled is the same as the I/O operation performance with delegation disabled. Based on this condition, the recall ratio at an inflection point, that is, the delegation enable threshold R_{i_tp}, may be determined by the following equation (9):

$${R}_{i \_ tp} = \frac{2 t * {FIO}_{i} * T * {fs}_{i \_ iops} - 2 t * {FIO}_{i}}{4 t * {FIO}_{i} * T * {fs}_{i \_ iops} - 2 t * {FIO}_{i}} \qquad ( 9 )$$

As can be seen from the above equations (6), (7), and (8), when the recall ratio Rᵢ is greater than R_{i_tp}, the total time consumed by all access requests when delegation is enabled is greater than the total time consumed by all access requests when delegation is not enabled. Therefore, enabling a delegation will result in a decrease in the I/O operation performance. On the contrary, when the recall ratio Rᵢ is less than R_{i_tp}, the total time consumed by all access requests when delegation is enabled is less than the total time consumed by all access requests when delegation is not enabled. Therefore, enabling a delegation will improve the I/O operation performance.

In this way, the delegation enable threshold can be accurately determined, and therefore, the accuracy of the delegation analyzer in deciding to enable or disable a delegation can be improved, thereby improving the I/O operation performance, saving network resources, reducing the latency, and improving the user experience.

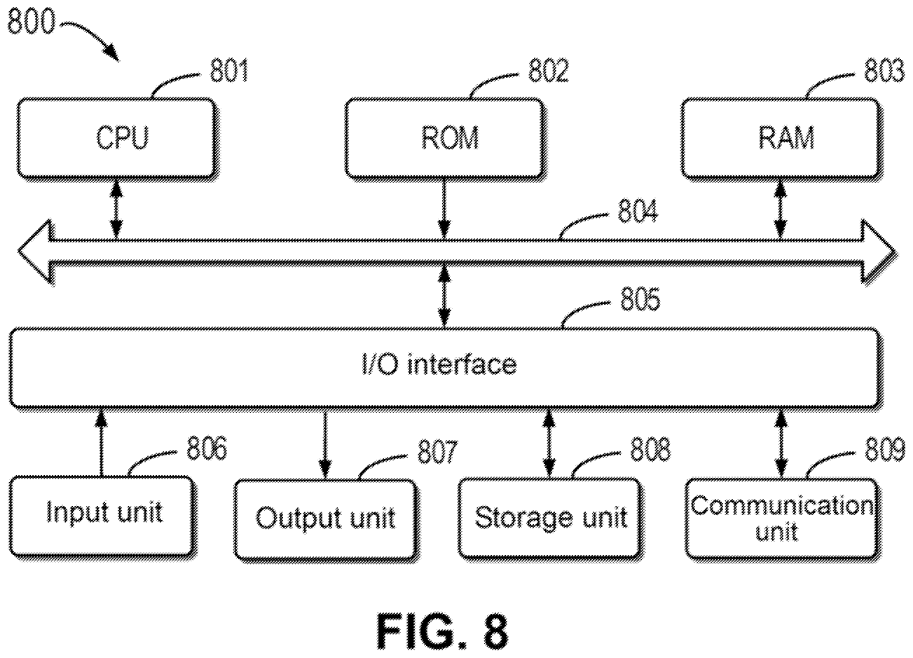

FIG. 8 shows a schematic block diagram of an example device 800 that may be used to implement an embodiment of the present disclosure. As shown in the figure, a device 800 includes a computing unit 801, which may execute various appropriate actions and processing according to computer program instructions stored in a read-only memory (ROM) 802 or computer program instructions loaded from a storage unit 808 onto a random access memory (RAM) 803. Various programs and data required for the operation of the device 800 may also be stored in the RAM 803. The computing unit 801, the ROM 802, and the RAM 803 are connected to each other through a bus 804. An input/Output (I/O) interface 805 is also connected to the bus 804.

A plurality of components in the device 800 are connected to the I/O interface 805, including: an input unit 806, such as a keyboard and a mouse; an output unit 807, such as various types of displays and speakers; a storage unit 808, such as a magnetic disk and an optical disc; and a communication unit 809, such as a network card, a modem, and a wireless communication transceiver. The communication unit 809 allows the device 800 to exchange information/data with other devices via a computer network, such as the Internet, and/or various telecommunication networks.

The computing unit 801 may be various general-purpose and/or special-purpose processing components with processing and computing capabilities. Some examples of the computing unit 801 include, but are not limited to, central processing units (CPUs), graphics processing units (GPUs), various specialized artificial intelligence (AI) computing chips, various computing units for running machine learning model algorithms, digital signal processors (DSPs), and any appropriate processors, controllers, microcontrollers, etc. The computing unit 801 performs various methods and processes described above, such as the method 300. For example, in some embodiments, the method 300 may be implemented as a computer software program that is tangibly included in a machine-readable medium such as the storage unit 808. In some embodiments, part or all of the computer program may be loaded and/or installed onto the device 800 via the ROM 802 and/or the communication unit 809. When the computer program is loaded to the RAM 803 and executed by the computing unit 801, one or more steps of the method 300 described above may be performed. Alternatively, in other embodiments, the computing unit 801 may be configured to implement the method 300 in any other suitable manners (such as by means of firmware).

The functions described herein above may be performed, at least in part, by one or more hardware logic components. For example, without limitation, example types of available hardware logic components include: a Field Programmable Gate Array (FPGA), an Application Specific Integrated Circuit (ASIC), an Application Specific Standard Product (ASSP), a System on Chip (SOC), a Load Programmable Logic Device (CPLD), and the like.

Program code for implementing the method of the present disclosure may be written by using one programming language or any combination of a plurality of programming languages. The program code may be provided to a processor or controller of a general purpose computer, a special purpose computer, or another programmable data processing apparatus, such that the program code, when executed by the processor or controller, implements the functions/operations specified in the flow charts and/or block diagrams. The program code may be executed completely on a machine, executed partially on a machine, executed partially on a machine and partially on a remote machine as a stand-alone software package, or executed completely on a remote machine or server.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable storage medium may include one or more wire-based electrical connections, a portable computer diskette, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combinations thereof. Additionally, although operations are depicted in a particular order, this should be understood that such operations are required to be performed in the particular order shown or in a sequential order, or that all illustrated operations should be performed to achieve desirable results. Under certain environments, multitasking and parallel processing may be advantageous. Likewise, although the above discussion contains several specific implementation details, these should not be construed as limitations to the scope of the present disclosure. Certain features that are described in the context of separate embodiments may also be implemented in combination in a single implementation. Conversely, various features that are described in the context of a single implementation may also be implemented in a plurality of implementations separately or in any suitable sub-combination.

Although the present subject matter has been described using a language specific to structural features and/or method logical actions, it should be understood that the subject matter defined in the appended claims is not necessarily limited to the particular features or actions described above. Rather, the specific features and actions described above are merely example forms of implementing the claims.

What is claimed is:

1. A method, comprising:
determining, by a system comprising at least one processor, a delegation enable status of a file system;
determining a number of access requests from clients to a file in the file system within a specified time period;
determining a recall ratio within the specified time period based on the delegation enable status and the number of access requests; and
updating the delegation enable status of the file system by comparing the recall ratio with a delegation enable threshold.

2. The method according to claim 1, wherein determining the recall ratio within the specified time period comprises:
in response to determining that the delegation enable status of the file system is disabled:
determining a predicted total number of recalls within the specified time period based on the number of access requests;
determining a total number of access requests within the specified time period; and
determining a predicted recall ratio based on the predicted total number of recalls and the total number of access requests.

3. The method according to claim 2, wherein determining the predicted total number of recalls within the specified time period comprises:
determining, for the file in the file system, a degree of dispersion of numbers of access requests within respective time periods from the clients to the file, the numbers comprising the number; and
determining the predicted number of recalls for the file based on the degree of dispersion and by determining one or more predicted numbers of recalls for one or more files in the file system.

4. The method according to claim 3, wherein determining the degree of dispersion of the numbers of access requests from the clients to the file comprises:
determining, based on the numbers of access requests, an average number of access requests from the clients to the file;
determining, based on the average number of access requests, a standard deviation of the numbers of access requests from the clients to the file; and
determining the standard deviation as the degree of dispersion.

5. The method according to claim 4, wherein updating the delegation enable status of the file system comprises:
updating, in response to the recall ratio being less than or equal to the delegation enable threshold, the delegation enable status of the file system to enabled.

6. The method according to claim 1, wherein determining the recall ratio within the specified time period further comprises:
in response to determining that the delegation enable status of the file system is enabled:
determining the number of access requests from the clients to the file in the file system within the specified time period;
determining a number of recalls associated with the file within the specified time period; and
determining the recall ratio based on the number of access requests and the number of recalls.

7. The method according to claim 6, wherein updating the delegation enable status of the file system comprises:
updating, in response to the recall ratio being greater than the delegation enable threshold, the delegation enable status of the file system to disabled.

8. The method according to claim 1, further comprising:
determining the delegation enable threshold based on a request time consumed by sending access requests, a response time consumed by receiving request responses, a total number of access requests to the file system within the specified time period, a number of requests per second of the file system within the specified time period, and a delegation timeout time.

9. The method according to claim 8, wherein determining the delegation enable threshold comprises:
determining a first consumption time, the first consumption time being a total time consumed by the access requests to the file in the file system without enabling the delegation of the file system within the specified time period;
determining a second consumption time, the second consumption time being a total time consumed by the access requests to the file in the file system when the delegation of the file system is enabled within the specified time period; and
determining the delegation enable threshold based on the first consumption time and the second consumption time.

10. The method according to claim 9, wherein determining the first consumption time comprises:
determining the first consumption time based on the request time, the response time, and the total number of access requests.

11. The method according to claim 9, wherein determining the second consumption time comprises:
determining a third consumption time, the third consumption time being a total time consumed by access requests that have undergone a recall;
determining a fourth consumption time, the fourth consumption time being a total time consumed by access requests that have not undergone a recall; and
determining the second consumption time based on the third consumption time and the fourth consumption time.

12. The method according to claim 11, wherein determining the third consumption time comprises:
determining the third consumption time based on the request time, the response time, and the number of access requests that have undergone a recall.

13. The method according to claim 11, wherein determining the fourth consumption time comprises:
determining the fourth consumption time based on the request time, the response time, the number of requests per second, the delegation timeout time, and the number of access requests that have not undergone a recall.

14. A device, comprising:
at least one processor; and
a storage apparatus, the storage apparatus being coupled to the at least one processor and having instructions stored thereon, wherein the instructions, when executed by the at least one processor, cause the device to perform actions comprising:
determining a delegation enable status of a file system;
determining the a of access requests from clients to a file in the file system within a defined time period;
determining a recall ratio within the defined time period based on the delegation enable status and the number of access requests; and
updating the delegation enable status of the file system by comparing the recall ratio with a delegation enable threshold.

15. The device according to claim 14, wherein determining the recall ratio within the defined time period comprises:
in response to determining that the delegation enable status of the file system is disabled:
determining a predicted total number of recalls within the defined time period based on the number of the access requests;
determining a total number of access requests within the defined time period; and
determining a predicted recall ratio based on the predicted total number of recalls and the total number of access requests.

16. The device according to claim 15, wherein determining the predicted total number of recalls within the defined time period comprises:
determining, for the file in the file system, a degree of dispersion of numbers of access requests, during respective defined periods of time, from the clients to the file, wherein the numbers of access requests comprise the number of access requests during the defined period of time;
determining a predicted number of recalls for the file based on the degree of dispersion; and
determining the predicted total number of recalls by determining one or more predicted numbers of recalls for one or more files in the file system.

17. The device according to claim 16, wherein determining the degree of dispersion of the numbers of access requests from the clients to the file comprises:
determining an average number of access requests from the clients to the file;
determining, based on the average number of access requests, a standard deviation of the numbers of access requests from the clients to the file, and
assigning the standard deviation to be the degree of dispersion.

18. The device according to claim 17, wherein updating the delegation enable status of the file system comprises:
updating, in response to the recall ratio being less than or equal to the delegation enable threshold, the delegation enable status of the file system to enabled.

19. A computer program product, the computer program product being stored on a non-transitory computer-readable medium and comprising machine-executable instructions, wherein the machine-executable instructions, when executed, cause a machine to perform actions comprising:
determining a delegation enable status of a file system;
determining a number of a plurality of access requests from a plurality of clients to a file in the file system within a predetermined time period;
determining a recall ratio within the predetermined time period based on the delegation enable status and the number of the plurality of access requests; and
updating the delegation enable status of the file system by comparing the recall ratio with a delegation enable threshold.

20. The computer program product according to claim 19, wherein determining the recall ratio within the predetermined time period comprises:
in response to determining that the delegation enable status of the file system is enabled:
determining the number of the plurality of access requests from the plurality of clients to the file in the file system within the predetermined time period;
determining the number of recalls associated with the file within the predetermined time period; and
determining the recall ratio based on the number of the plurality of access requests and the number of recalls.
